(19) United States
(12) Patent Application Publication
(10) Pub. No.: US 2004/0080146 A1
(43) Pub. Date: Apr. 29, 2004

(54) Airbag module including gas lance

(75) Inventors: Joachim Lutz, Schechingen (DE); Jens Debler, Herlikofen (DE); Dirk Schultz, Heubach (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/689,007

(22) Filed: Oct. 20, 2003

(30) Foreign Application Priority Data
Oct. 23, 2002 (DE) 102 49 375.8

(51) Int. Cl. B60R 21/26

(52) U.S. Cl. 280/736

(57) ABSTRACT

An airbag module (10; 110) for a vehicle occupant restraint system comprises a gas lance (22; 122) that can feed gas from a source of compressed gas (40; 140) into an airbag (20; 120), and a housing (12; 112) which accommodates the gas lance. The gas lance (22; 122) has a connection extension (36; 136) for being connected to the source of compressed gas (40; 140). The connection extension (36; 136) projects so far out of the housing (12; 112) that it can penetrate into the source of compressed gas (40; 140) installed outside of the housing. The connection extension serves to supply the gas lance (22; 122) with compressed gas from the source of compressed gas (40; 140) as well as to mechanically attach the source of compressed gas (40; 140) to the airbag module (10; 110).

### TECHNICAL FIELD

The invention relates to an airbag module for a vehicle occupant restraint system.

### BACKGROUND OF THE INVENTION

An airbag module typically comprises a gas lance that can feed the gas from a source of compressed gas into an airbag, and a housing which accommodates the gas lance, the gas lance having a connection extension for being connected to the source of compressed gas.

The use of a gas lance for gas distribution allows the source of compressed gas to be accommodated outside of the airbag module. First of all, this offers greater freedom in designing the airbag module, for example, in the case of cramped space conditions, and secondly, a source of compressed gas installed outside of the airbag module can be replaced more easily if this should become necessary. For this purpose, with the known airbag modules of this type, the source of compressed gas has to be attached in the vehicle. Moreover, there might be a need for a detachable connection between the gas lance and the source of compressed gas.

The invention is based on the object of providing an airbag module with a gas lance that offers a simple connection for a source of compressed gas and that facilitates the assembly of a source of compressed gas in the vehicle.

### BRIEF SUMMARY OF THE INVENTION

According to the invention, airbag module for a vehicle occupant restraint system comprises a gas lance that can feed gas from a source of compressed gas into an airbag, and a housing which accommodates the gas lance. The gas lance has a connection extension for being connected to the source of compressed gas. The connection extension projects so far out of the housing that it can penetrate into the source of compressed gas installed outside of the housing. The connection extension serves to supply the gas lance with compressed gas from the source of compressed gas as well as to mechanically attach the source of compressed gas to the airbag module.

This configuration makes it possible to connect the source of compressed gas, for instance a gas generator, to the airbag module and, at the same time, to attach it without a need for additional attachment means. In this way, the gas generator can be installed especially simply and inexpensively outside of the airbag module. Also for the eventuality that the gas generator needs to be replaced, this is particularly easy with the configuration according to the invention of the airbag module.

Additional embodiments and their advantages will be apparent from the subordinate claims.

### BRIEF DESCRIPTION OF THE DRAWINGS

FIG. 1 is a first, partially cutaway view of a first embodiment of an airbag module according to the invention with an associated gas generator;

FIG. 2 is a second view of the airbag module of FIG. 1;

FIG. 3 is a third, sectioned view of the airbag module of FIG. 1;

FIG. 4 shows a cross section through the airbag module of FIG. 1 in the plane indicated by IV in FIG. 2;

FIG. 5 is a first, partially sectioned view of a second embodiment of the airbag module according to the invention with an associated gas generator;

FIG. 6 is a second view of the airbag module of FIG. 5;

FIG. 7 is a view of the housing of the airbag module of FIG. 5;

FIG. 8 is a view of the gas lance and of the gas generator of the airbag module of FIG. 5; and

FIG. 9 shows a cross section through the airbag module of FIG. 5 in the lane indicated by IX in FIG. 6.

### DETAILED DESCRIPTION OF THE PREFERRED EMBODIMENTS

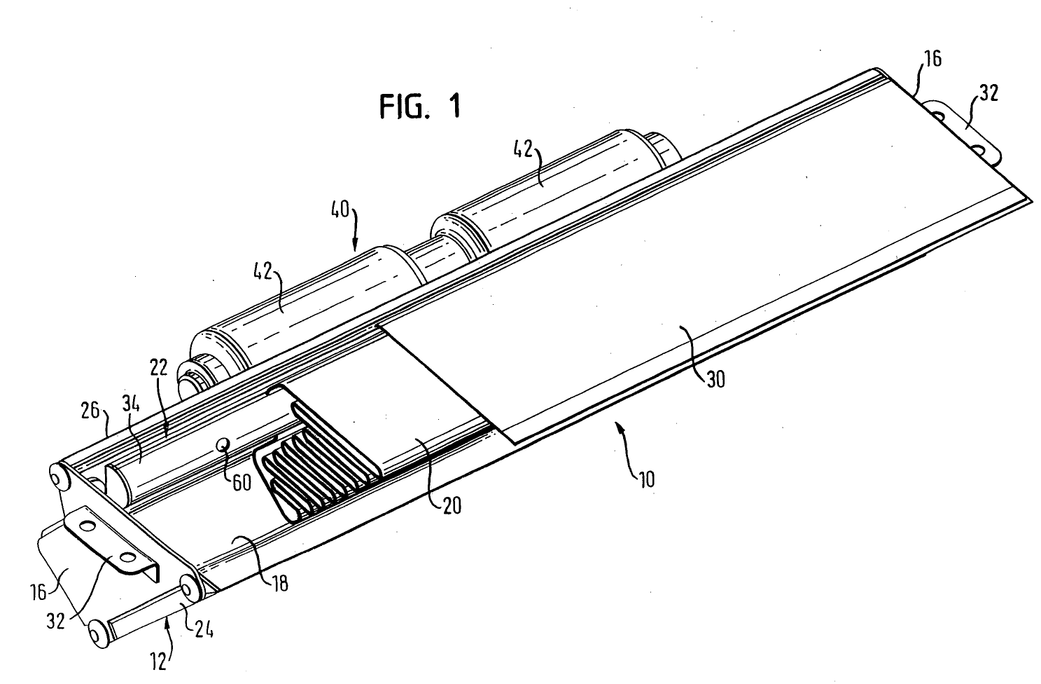

A first embodiment of an airbag module 10 according to the invention is shown in FIG. 1. The airbag module 10 has a housing 12 consisting of an extruded metal profile 14 with an essentially U-shaped cross section. The housing is closed on its end faces with screwed-on side covers 16. The U-shaped profile 14 forms a tub-shaped receptacle 18 that opens up into an ejection opening 28. The two legs of the profile 14 form a front lengthwise wall 24 and a back lengthwise wall 26, the back lengthwise wall 26 being angled in such a way that the cross section of the receptacle 18 widens towards the ejection opening.

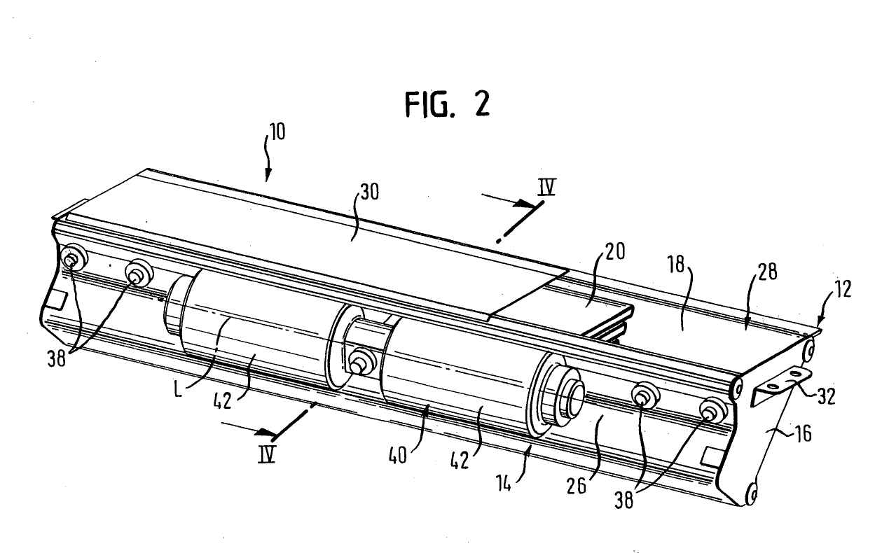

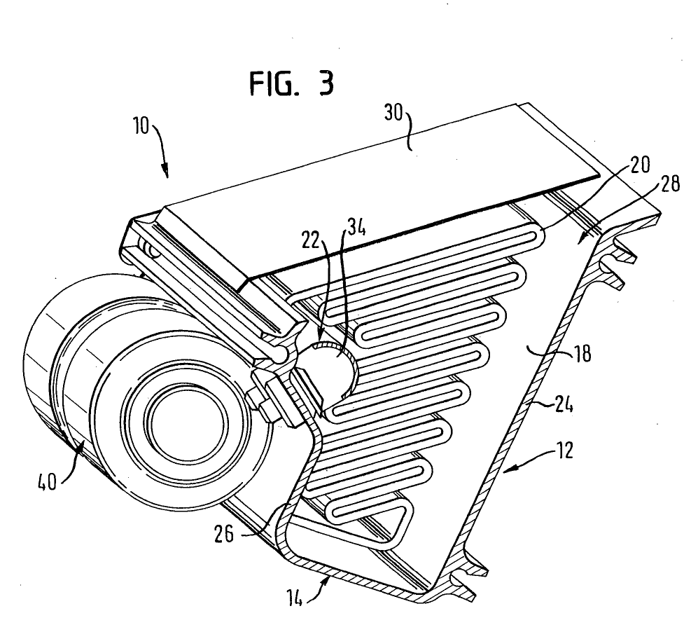

The receptacle 18 houses a folded airbag 20 in which a gas lance 22 is wrapped that is attached to the back lengthwise wall 26. In order to protect the airbag 20, the ejection opening 28 is closed with a protective cover 30; in FIGS. 1 through 3, the protective cover 30 as well as the folded airbag 20 are only partially shown in order not to cover up the other components of the airbag module 10.

Moreover, in order to attach the airbag module 10 in the vehicle, fastening brackets 32 are installed on the side covers 16 of the housing 12.

As can be seen best in FIG. 8, the gas lance 22 has an elongated crosswise tube 34 with a connection extension 36, preferably extending radially in the middle of the crosswise tube 34, which gives the gas lance 22 the shape of a T. The crosswise tube 34 has attachment means, for example, in the form of welded-on threaded bolts 38 that serve to attach the gas lance 22 in the housing 12. For this purpose, the back lengthwise wall 26 of the housing 12 is provided with boreholes through which the threaded bolts 38 can pass and tightened externally of the airbag module 10 by means of nuts. The connection extension 36 projects through another borehole 39 in the back lengthwise wall 26 for connecting the gas lance 22 to a source of compressed gas, for example, to a gas generator 40.

The tubular gas generator 40 used with this embodiment of the airbag module 10 consists of two cylindrical co-linear combustion chambers 42 that are connected to each other by a connection tube 44 so that the gas generator 40 has a generally dumbbell-shaped design with a longitudinal axis L. The connection tube 44 is flattened so that it has two parallel contact surfaces across from each other. The connection tube 44 is provided with a passage borehole 46 that extends perpendicularly and crosswise to the longitudinal axis L of the gas generator 40 through the contact surfaces. The connection extension 36 projects through the passage borehole 46 and thus constitutes the connection of the gas lance 22 to the gas generator 40.

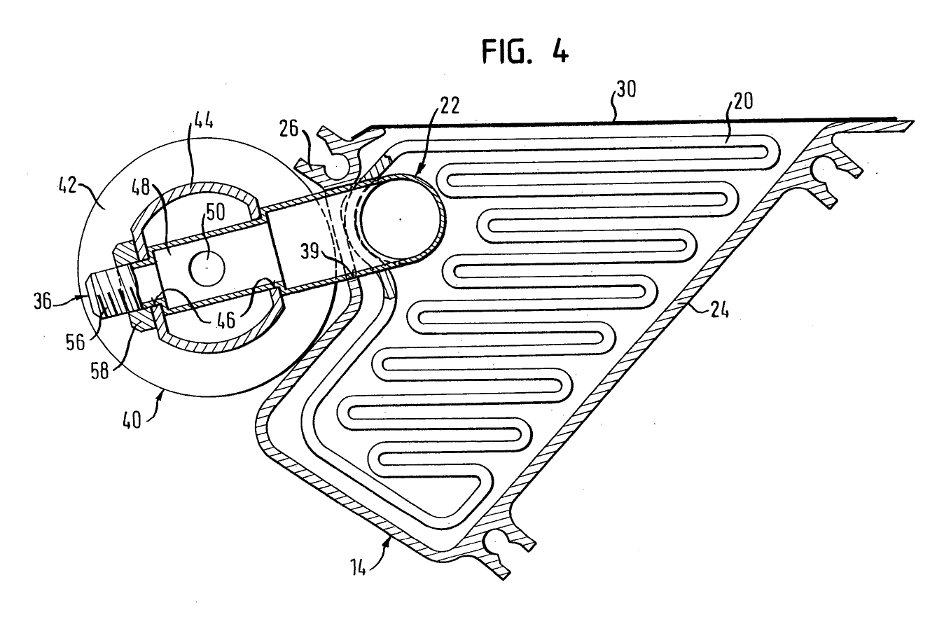

As can be seen in FIG. 4, in the area of a connection section 48 extending through the connection tube 44, the connection extension 36 has inlet openings 50 that preferably lie on the longitudinal axis L of the gas generator 40 and through which the compressed gas generated by the gas generator 40 can flow into the gas lance 22. At its free end, which projects from the connection tube 44 on the side of the gas generator 40 facing away from the housing 12, the connection extension 36 is provided with an end piece 56 that has an outer thread. Consequently, the gas generator 40 can be attached to the airbag module 10 by means of a nut 58 that is screwed onto the end piece 56. Thus, the connection extension 36 serves concurrently as a mechanical attachment element for the gas generator 40 and as a flow connection from the gas generator 40 to the gas lance 22. In this manner, the compressed gas generated in the gas generator 40 can be fed from the gas lance 22 into the receptacle 18 of the housing 12, where it can flow through outflow openings 60 located in the crosswise tube 34 into the airbag 20 in order to inflate it.

The method of attachment of the gas generator at the end of the connection extension is merely given by way of an example. The gas generator can be equally advantageously attached in another manner to the free end of the connection extension, even if the free end of the connection extension does not project out of the connection tube. Instead, for example, a screw or a threaded bush that engages the free end of the connection extension can project into the connection tube from the opposite side, that is to say, from the side of the gas generator facing away from the housing. Or else the gas generator can have a fastening element in its interior that engages the connection extension.

Through the T-shaped design of the gas lance 22, the gas flowing at high speed is advantageously guided in two opposite directions, as a result of which a reaction moment on the housing 12 is largely avoided.

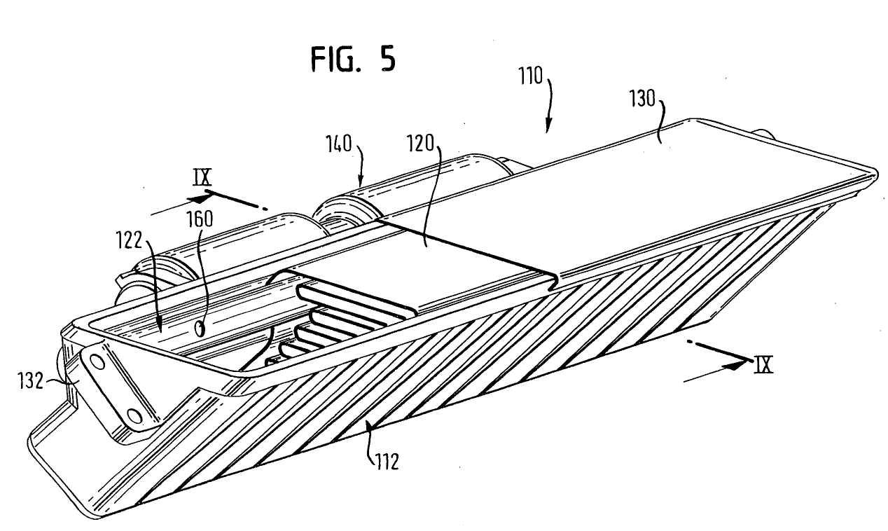

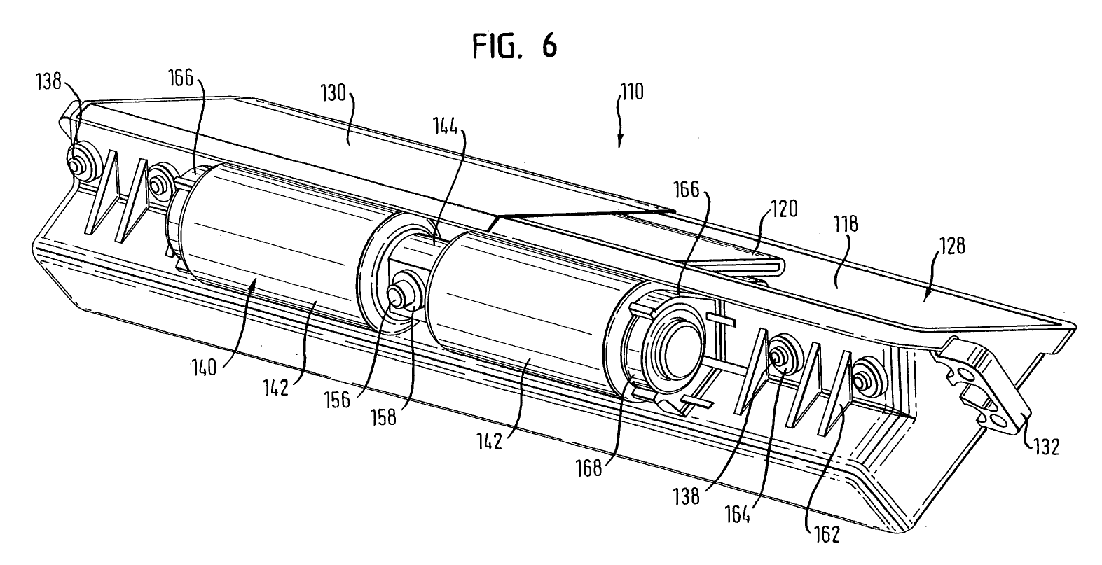

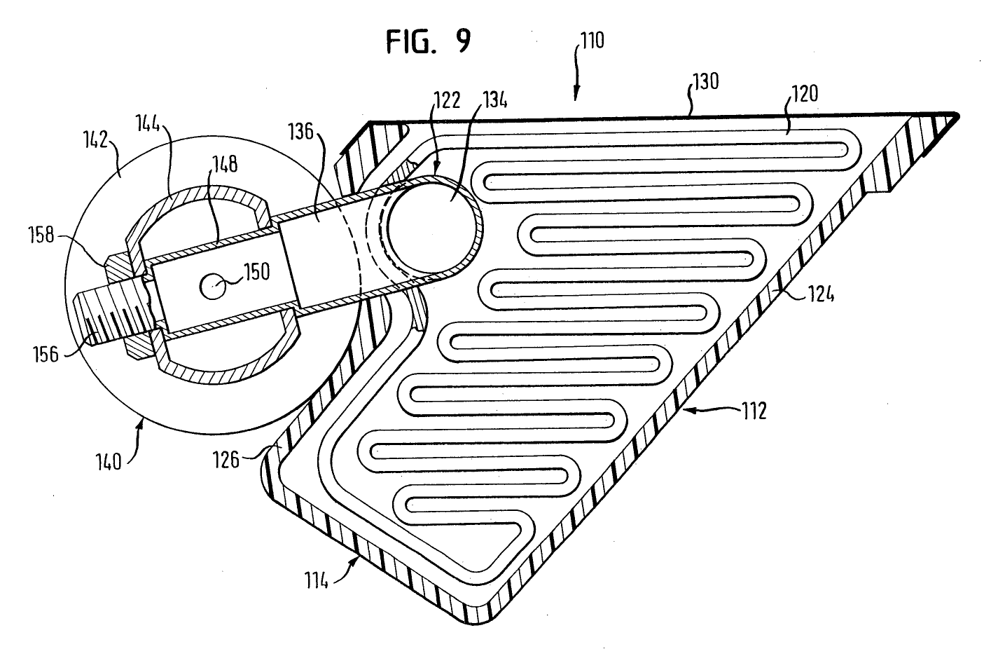

A second embodiment of an airbag module 110 according to the invention is shown in FIGS. 5 to 9, reference numerals increased by 100 being used for components already described.

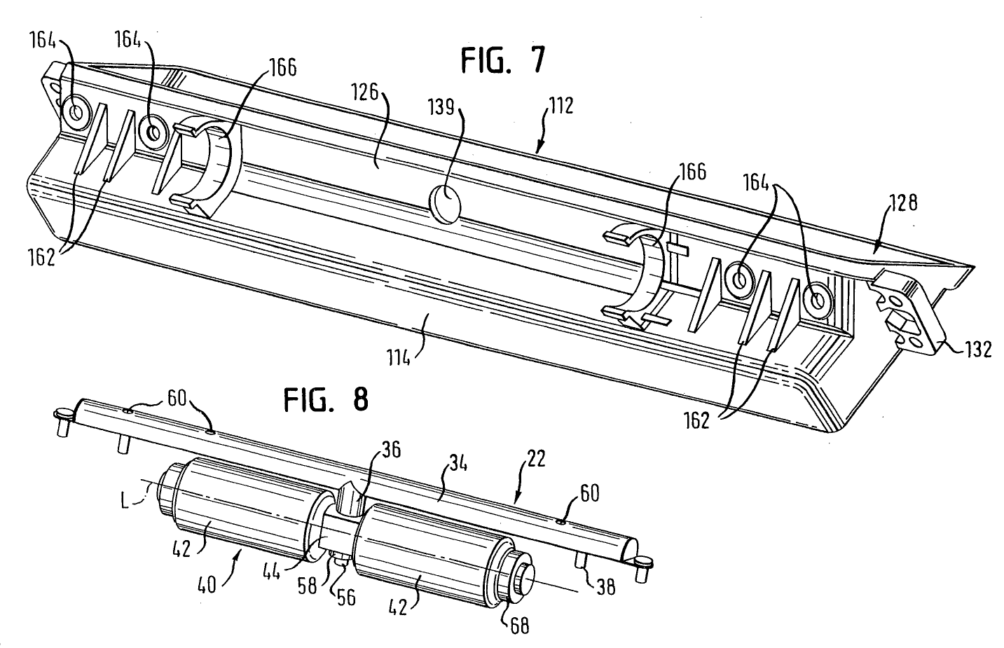

The airbag module 110 differs from the previously described embodiment essentially in that the housing 112 is made as an injection-molded or cast part, for example, of plastic. The use of a plastic housing accounts for a major weight savings. As can be seen in FIG. 7, the back lengthwise wall 126 is supported by additional webs 162. Moreover, the back lengthwise wall 126 can be reinforced in the area of the boreholes for the threaded bolts 138 by a greater wall thickness or by inserted metal bushings 164 in order to ensure a secure attachment of the gas lance 122.

Moreover, there are two holding clamps 166 formed on the back lengthwise wall 126, and they can offer an additional support for the gas generator 140 in that they grasp around cylindrical extensions 168 at the free ends of the combustion chambers 142 of the gas generator 140.

In addition to the described configuration of the housing as a plastic part offering the advantages of lower weight, greater design flexibility and a single-piece design, other versions are, of course, also conceivable, for example, housings made of aluminum or steel parts made by stamping-bending or deep-drawing techniques.

1. An airbag module (10; 110) for a vehicle occupant restraint system, said airbag module comprising a gas lance (22; 122) that can feed gas from a source of compressed gas (40; 140) into an airbag (20; 120), and a housing (12; 112) which accommodates said gas lance, said gas lance (22; 122) having a connection extension (36; 136) for being connected to said source of compressed gas (40; 140), characterized in that said connection extension (36; 136) projects so far out of said housing (12; 112) that it can penetrate into said source of compressed gas (40; 140) installed outside of said housing and it serves to supply said gas lance (22; 122) with compressed gas from said source of compressed gas (40; 140) as well as to mechanically attach said source of compressed gas (40; 140) to said airbag module (10; 110).

2. The airbag module according to claim 1, characterized in that said connection extension (36; 136) projects so far out of said housing (12; 112) that it can penetrate right through said source of compressed gas (40; 140) installed outside of said housing.

3. The airbag module according to claim 1, characterized in that said connection extension (36; 136) has two ends and is provided with a thread on one of said ends (56; 156) which faces away from said gas lance (22; 122).

4. The airbag module according to claim 1, characterized in that said gas lance (22; 122) is T-shaped in an area of said connection extension (36; 136).

5. The airbag module according to claim 1, characterized in that said housing is configured as an extruded profile.

6. The airbag module according to claim 1, characterized in that said housing (112) is made of plastic.

7. The airbag module according to claim 1, characterized in that a tubular source of compressed gas (40; 140) with a longitudinal axis (L) is attached to said airbag module (10; 110), said connection extension (36; 136) penetrating into said source of compressed gas crosswise to said longitudinal axis (L).

8. The airbag module according to claim 7, characterized in that said connection extension (36; 136) penetrates said source of compressed gas (40; 140) in a middle thereof.

9. The airbag module according to claim 1, characterized in that said housing (12; 112) accommodates an airbag (20; 120) that surrounds said gas lance (22; 122).
